(19) United States
(12) Patent Application Publication
(10) Pub. No.: US 2026/0214175 A1
(43) Pub. Date: Jul. 23, 2026

(54) IMAGE READING DEVICE AND IMAGE FORMING APPARATUS

(71) Applicants: Masafumi KISHI, Kanagawa (JP); Atsushi SUGAI, Tokyo (JP)

(72) Inventors: Masafumi KISHI, Kanagawa (JP); Atsushi SUGAI, Tokyo (JP)

(21) Appl. No.: 19/398,125

(22) Filed: Nov. 24, 2025

(30) Foreign Application Priority Data
Jan. 21, 2025 (JP) 2025-008168

(51) Int. Cl. H04N 1/028; G03G 15/22

(52) U.S. Cl. CPC H04N 1/02885; G03G 15/228; H04N 1/0288; H04N 2201/0081

(57) ABSTRACT

An image reading device includes first light sources disposed on a first surface of a substrate to emit first illuminating light, second light sources disposed on a second surface of the substrate opposite to the first surface to emit second illuminating light, an image reading sensor, and a light guide device. The image reading sensor reads an image of a reading target in an image reading area irradiated with the first illuminating light and the second illuminating light, which have different spectroscopic characteristics. The light guide device guides the first illuminating light and the second illuminating light to the image reading area via a light guide such that a peak light amount position of the first illuminating light in the image reading area and a peak light amount position of the second illuminating light in the image reading area are substantially identical.

### CROSS-REFERENCE TO RELATED APPLICATION

This patent application is based on and claims priority pursuant to 35 U.S.C. § 119(a) to Japanese Patent Application No. 2025-008168, filed on Jan. 21, 2025, in the Japan Patent Office, the entire disclosure of which is hereby incorporated by reference herein.

### BACKGROUND

### Technical Field

The present disclosure relates to an image reading device and an image forming apparatus.

### Related Art

There is an image reading device including a first light source unit, a second light source unit, and an image reading unit. The first light source unit is disposed on a first surface of a substrate. The second light source unit is disposed on a second surface of the substrate opposite to the first surface. The image reading unit reads an image of a reading target in an image reading area irradiated with illuminating light from the first light source unit and the second light source unit.

For example, there is disclosed an image reading device including a plurality of light-emitting elements mounted on the front and back surfaces of a substrate. The image reading device emits light from the light-emitting elements in a direction parallel to the substrate surfaces to illuminate a document scanning position (image reading area) for scanning a document (reading target) on a document table glass.

### SUMMARY

The present disclosure described herein provides an image reading device that includes, for example, a plurality of first light sources, a plurality of second light sources, an image reading sensor, and a light guide device. The plurality of first light sources are disposed on a first surface of a substrate to emit first illuminating light. The plurality of second light sources are disposed on a second surface of the substrate opposite to the first surface to emit second illuminating light. The image reading sensor reads an image of a reading target in an image reading area irradiated with the first illuminating light and the second illuminating light. The first illuminating light and the second illuminating light have different spectroscopic characteristics. The light guide device guides the first illuminating light and the second illuminating light to the image reading area via a light guide such that a peak light amount position of the first illuminating light in the image reading area and a peak light amount position of the second illuminating light in the image reading area are substantially identical.

The present disclosure described herein further provides an image forming apparatus that includes, for example, the above-described image reading device and an image forming device that forms an image on a sheet.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of a copier according to an embodiment of the present disclosure;

FIG. 2 is a schematic diagram illustrating a configuration of a scanner included in the copier;

FIG. 3 is a block diagram illustrating part of an electric circuit of the scanner;

FIG. 4 is a diagram schematically illustrating a configuration of a light source device of the scanner;

FIG. 5 is a schematic perspective view of a light source substrate of the light source device;

FIG. 6 is a diagram illustrating a state of white light and infrared light guided by a light guide of the light source device;

FIG. 7 is a graph illustrating an example of light distributions in an image reading area of the white light and the infrared light emitted from the light source device; and

FIG. 8 is a diagram illustrating an example of an image sensor of the scanner.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An embodiment of the present disclosure applied to an electrophotographic copier (hereinafter simply referred to as the copier) as an image forming apparatus will be described.

A basic configuration of the copier according to the embodiment will first be described.

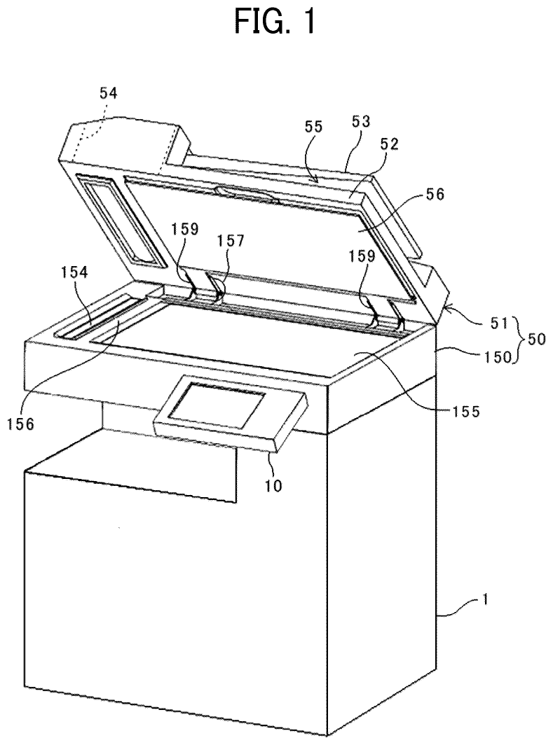

FIG. 1 is a perspective view of the copier according to the embodiment. The copier includes an image forming unit 1 as image forming means and an image reading unit 50. The image reading unit 50 includes a scanner 150, which is an image reading device fixed on the image forming unit 1, and an automatic document feeder (ADF) 51 supported by the scanner 150.

The image forming unit 1 forms an image on a recording sheet through a known electrophotographic process. Specifically, the image forming unit 1 forms an image as follows. The image forming unit 1 feeds a recording sheet from a sheet feeding cassette into a sheet feeding path. The recording sheet fed in the sheet feeding path hits against a nip between a pair of registration rollers and temporarily stops being transported. The image forming unit 1 includes an optical writing device, four imaging units for separately forming black (K), yellow (Y), magenta (M), and cyan (C) toner images, a transfer unit, a sheet transport unit, and a fixing device, for example. The image forming unit 1 drives light sources such as laser diodes or light-emitting diodes (LEDs) disposed in the optical writing device to irradiate drum-shaped photoconductors included in the four imaging units with laser beams. Through this irradiation, electrostatic latent images are formed on respective surfaces of the photoconductors for the K, Y, M, and C colors. The electrostatic latent images are then developed into K, Y, M, and C toner images through a known development process.

The transfer unit causes an endless intermediate transfer belt stretched by a plurality of rollers to rotate while in contact with the photoconductors for the K, Y, M, and C colors. Thereby, first transfer nips for the K, Y, M, and C colors are formed at which the photoconductors for the K, Y, M, and C colors come in contact with the endless intermediate transfer belt. The K, Y, M, and C toner images formed on the photoconductors for the K, Y, M, and C colors are first-transferred onto the intermediate transfer belt to be superimposed on each other. The K, Y, M, and C toner images are then second-transferred at one time onto the recording sheet to form a full-color toner image. Thereafter, the recording sheet passes through the fixing device to fix the full-color toner image on the recording sheet.

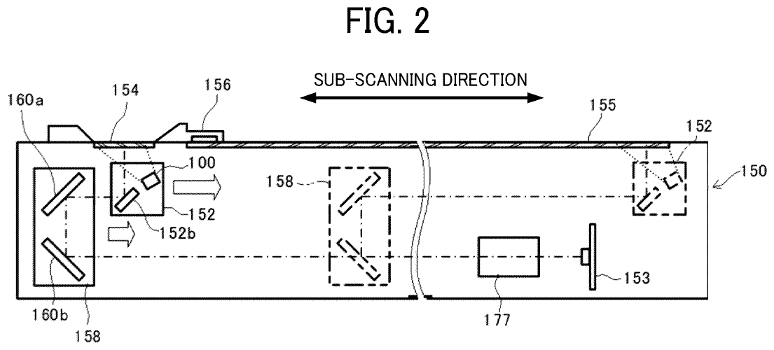

The scanner 150 fixed on the image forming unit 1 includes a movable irradiation unit 152 (see FIG. 2), which has a home position directly under a second contact glass 154.

The movable irradiation unit 152 includes an optical system with components such as a light source device 100 (see FIG. 2) and a reflecting mirror. The movable irradiation unit 152 is movable in the sub-scanning direction, which corresponds to the horizontal direction in FIG. 2. Illuminating light emitted from the light source device 100 is reflected by a document surface of a document (reading target) transported onto the second contact glass 154 by the ADF 51. The illuminating light is then reflected by the reflecting mirrors and received by an image sensor 153 (see FIG. 2) fixed to the body of the scanner 150 as an image reader. The movable irradiation unit 152 is movable from the home position to a position directly under a first contact glass 155, which is fixed to an upper wall of a casing of the scanner 150.

The ADF 51 disposed on the scanner 150 has a body cover 52 holding a document placement table 53 on which a document before being read is placed. The ADF 51 further includes a transport unit 54 for transporting a sheet-like document and a document stacking table 55 for stacking read documents, for example. With hinges 159 fixed to the scanner 150, the ADF 51 is supported to be vertically swingable. The ADF 51 swings to move like an opening and closing door. With the ADF 51 open, the first contact glass 155 and the second contact glass 154 forming the upper surface of the scanner 150 are exposed.

In the case of side-bound documents such as a stack of documents bound at one corner into a book, the documents are not separable from each other and thus are not transportable by the ADF 51. In the case of the side-bound documents, therefore, the ADF 51 is opened as illustrated in FIG. 1, and the side-bound documents are opened to a page to read and placed face down on the first contact glass 155. Then, the ADF 51 is closed, and a copy start button is pressed. Thereby, the movable irradiation unit 152 of the scanner 150 starts moving from the home position directly under the second contact glass 154 toward the position directly under the first contact glass 155. Then, the illuminating light emitted from the light source device 100 is reflected by the document surface of the document on the first contact glass 155, and the reflected light is guided toward the image sensor 153. Thereby, the image of the document is read by the image sensor 153. The ADF 51 has a lower surface with a pressure board 56 fixed thereon so that the document placed on the first contact glass 155 as a document table is pressed against the first contact glass 155 by the pressure board 56.

In the case of a stack of documents separated from each other and simply stacked on each other, the documents may be automatically transported one by one onto the second contact glass 154 by the ADF 51 to allow the scanner 150 to sequentially read the images of the documents. In this case, a user sets the stack of documents on the document placement table 53 and presses the copy start button. Thereby, the ADF 51 sequentially feeds the documents from the stack of documents placed on the document placement table 53 into the transport unit 54, and transports each of the documents toward the document stacking table 55 while reversing the document. In this transport process, the ADF 51 passes the document through a position directly above the second contact glass 154 of the scanner 150 while reversing the document. Thereby, the image of a first surface of the document is scanned by the movable irradiation unit 152 stopped at the above-described home position, and is read by the image sensor 153.

The image reading unit 50 including the ADF 51 and the scanner 150 further includes an opening and closing sensor 157 formed by a rotary encoder that detects an opening and closing angle of the ADF 51, for example.

It is assumed in the following description that, when the opening and closing angle of the ADF 51 is 0°, the ADF 51 is in contact with the first contact glass 155 of the scanner 150 to completely cover the first contact glass 155. It is also assumed that, when the opening and closing angle of the ADF 51 is 90°, the ADF 51 is open to stand substantially vertically.

The first contact glass 155 is arranged such that the shorter direction and the longer direction of the plane of the first contact glass 155 run along the main scanning direction and the sub-scanning direction, respectively, in document scanning during document reading. Further, the movable irradiation unit 152 is arranged with the longer direction thereof running along the main scanning direction, and is movable in the sub-scanning direction by a moving mechanism. That is, the movable irradiation unit 152 is movable back and forth along the longer direction of the first contact glass 155. To read the image of the document placed on the first contact glass 155, the movable irradiation unit 152 moves from the left side to the right side of FIG. 2 in the sub-scanning direction. The left side and the right side of FIG. 2 in the sub-scanning direction during the document reading will hereinafter be referred to as the upstream side during the reading and the downstream side during the reading, respectively.

FIG. 2 is a schematic diagram illustrating a configuration of the scanner 150. The scanner 150 includes, in the casing thereof, the movable irradiation unit 152, a movable mirror unit 158, an optical lens 177, and the image sensor 153 such as a charge-coupled device (CCD) image sensor, for example. The scanner 150 further includes a first sub-scanning size sensor and a second sub-scanning size sensor, for example.

The movable irradiation unit 152 includes the light source device 100 and a first mirror 152b. The light source device 100 irradiates the document surface with light via the second contact glass 154 or the first contact glass 155. The movable irradiation unit 152 is movable in the sub-scanning direction (the horizonal direction in FIG. 2). As illustrated in FIG. 2, a position directly under the second contact glass 154 is set as the home position in the sub-scanning direction of the movable irradiation unit 152. In normal mode, the movable irradiation unit 152 stands by at the home position. During the transport of a set document, the ADF 51 passes the document through a position directly above the second contact glass 154. In this process, the light source device 100 of the movable irradiation unit 152 at the home position irradiates the document surface with light to read the image of the automatically transported document.

The movable mirror unit 158 disposed on the left side of the movable irradiation unit 152 in FIG. 2 includes a second mirror 160a and a third mirror 160b. The movable mirror unit 158 is movable in the sub-scanning direction. In the following description, the movement of the movable irradiation unit 152 or the movable mirror unit 158 from the left side to the right side of FIG. 2 will be referred to as the forward movement. Further, the movement of the movable irradiation unit 152 or the movable mirror unit 158 from the right side to the left side of FIG. 2 will be referred to as the backward movement. In the forward movement, the movable mirror unit 158 moves at half speed of the movable irradiation unit 152. Therefore, the distance between the movable mirror unit 158 and the movable irradiation unit 152 increases as the movable irradiation unit 152 and the movable mirror unit 158 move towards the right end of FIG. 2.

Modes for reading the image of the document include a placed document reading mode and an automatically transported document reading mode. The placed document reading mode is a mode for reading the image of a document placed on the first contact glass 155 by the user. The automatically transported document reading mode is a mode for reading the image of a document set on the ADF 51 while the document is automatically transported by the ADF 51 to a position directly above the movable irradiation unit 152 of the scanner 150 located at the home position. In the placed document reading mode, the scanner 150 performs a later-described length identification process to identify the length in the main scanning direction (a direction perpendicular to the plane of the drawing) of the document. In the automatically transported document reading mode, the ADF 51 identifies the length in the main scanning direction of the document with a plurality of optical sensors provided to the ADF 51.

In the case of side-bound documents such as a plurality of documents bound into a book, in which the documents are stacked and bounded on one side in the planar direction thereof, the ADF 51 is unable to automatically transport the documents individually; the automatically transported document reading mode is unavailable. In this case, therefore, the documents are read in the placed document reading mode. In the placed document reading mode, the movable irradiation unit 152 and the movable mirror unit 158 are moved forward to sequentially irradiate the document surface of each of the documents on the first contact glass 155 with light from the left side to the right side of FIG. 2 to read the image of the document. The light reflected by the document surface is sequentially reflected by the first mirror 152b, the second mirror 160a, and the third mirror 160b, and then is formed into an image on surfaces of imaging elements of the image sensor 153 through the optical lens 177. The image sensor 153 performs photoelectric conversion on the formed image of the reflected light to convert the image into an analog image signal.

In the present embodiment, the light source device 100 includes white light sources as a first light source unit and infrared light sources as a second light source unit, as described later. The white light sources emit white light, which is visible light as first illuminating light. The infrared light sources emit infrared light, which is invisible light as second illuminating light. The image sensor 153 of the present embodiment is capable of capturing an image in the visible region (acquiring image information of a visible light image) and capturing an image in the infrared region (acquiring image information of an infrared image as an invisible light image). Consequently, the image sensor 153 receives the reflected light from the document irradiated with the white light and the infrared light from the light source device 100, to thereby acquire the image information of the visible light image and the image information of the infrared image.

According to the present embodiment, in character recognition (optical character recognition (OCR)) performed on the image of the document, for example, the document image is read through irradiation with infrared light instead of white light. With the irradiation with infrared light, color information of the document image is disabled, increasing the accuracy of the character recognition.

Further, according to the present embodiment, an infrared image (an image visualized through irradiation with infrared light) is read through the irradiation with infrared light, for example. For instance, an infrared image printed on a certificate or a confidential document for forgery prevention is read through the irradiation with infrared light. Then, if the infrared image is detected, the document is prohibited from being copied to thereby prevent forgery. Further, an infrared image read from a document through the irradiation with infrared light may be printed with visible toner such as black toner to indicate that the document is a copy, to thereby prevent forgery.

In the automatically transported document reading mode, the image of the document passing over the second contact glass 154 is read with the movable irradiation unit 152 stopped at the home position and the movable mirror unit 158 stopped on the left side of the movable irradiation unit 152 in FIG. 2.

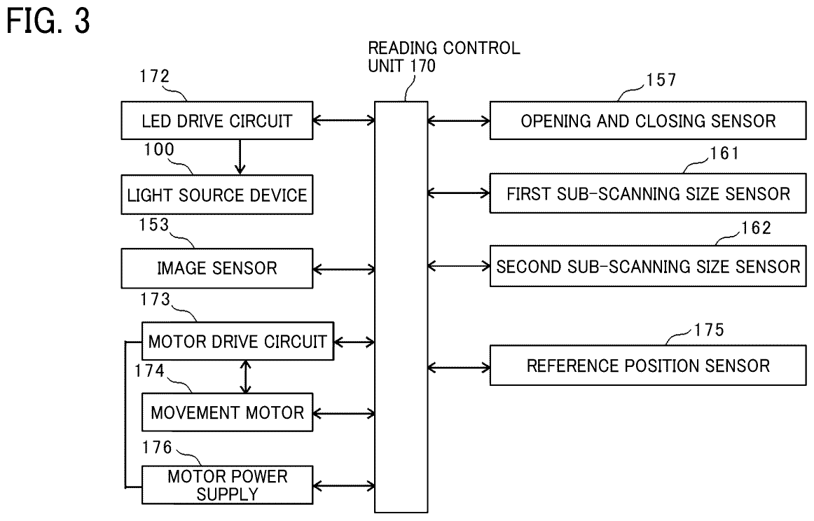

FIG. 3 is a block diagram illustrating part of an electric circuit of the scanner 150 in the copier according to the embodiment. In FIG. 3, a reading control unit 170 as control means includes a central processing unit (CPU), a random-access memory (RAM), and a read-only memory (ROM), for example. The reading control unit 170 is connected to the opening and closing sensor 157, a first sub-scanning size sensor 161, a second sub-scanning size sensor 162, an LED drive circuit 172, a motor drive circuit 173, a movement motor 174, a reference position sensor 175, and a motor power supply 176, for example. Functions of the opening and closing sensor 157, the light source device 100, and the image sensor 153 illustrated in FIG. 3 are as described above, and thus the description thereof will be omitted.

The reference position sensor 175, which is formed by a reflective photosensor, for example, detects whether the movable irradiation unit 152 is at a later-described reference position. The reference position sensor 175 then outputs the result of the detection to the reading control unit 170. Based on a signal from the reading control unit 170, the LED drive circuit 172 controls on and off of later-described LED elements as light sources of the light source device 100. The movement motor 174 as a drive source moves the movable irradiation unit 152 in the sub-scanning direction. The movement motor 174 is formed by a stepping motor. The excitement of the movement motor 174 is controlled by the motor drive circuit 173, and the drive amount and the drive direction of the movement motor 174 are controlled by the reading control unit 170. The motor power supply 176 supplies power to the motor drive circuit 173. If the power supply to the motor drive circuit 173 stops, power supply to the movement motor 174 also stops.

When standing by in normal mode for a command from the user, the movable irradiation unit 152 stays at the above-described home position. The ADF 51 is normally closed completely, covering the first contact glass 155. Therefore, the user opens the ADF 51 to place a document on the first contact glass 155. If the user starts opening the ADF 51 and the opening and closing angle of the ADF 51 increases from 0° and reaches 30°, the reading control unit 170 included in the scanner 150 recognizes that an operation of opening the ADF 51 has started. Then, based on the recognition, the reading control unit 170 moves the movable irradiation unit 152 from the home position to a document size detection position. In the present specification, one end in the sub-scanning direction of the movable irradiation unit 152 on the upstream side during the reading is described as a reference of position in the sub-scanning direction of the movable irradiation unit 152. When the movable irradiation unit 152 is moved to the document size detection position, therefore, the one end in the sub-scanning direction of the movable irradiation unit 152 on the upstream side during the reading is located at the document size detection position.

Each of the first sub-scanning size sensor 161 and the second sub-scanning size sensor 162 is formed by a reflective photosensor and emits light toward the first contact glass 155 at a position directly under the first contact glass 155. When the ADF 51 is open, the light emitted from light-emitting elements of the first sub-scanning size sensor 161 travels directly vertically upward through the first contact glass 155. Therefore, the light emitted from the light-emitting elements of the first sub-scanning size sensor 161 is not detected by light-receiving elements of the first sub-scanning size sensor 161 as reflected light. If a document is placed in an area of the planar surface of the first contact glass 155 directly above the first sub-scanning size sensor 161, on the other hand, the light emitted from the light-emitting elements of the first sub-scanning size sensor 161 is reflected by the surface of the document as reflected light. The reflected light is then received by the light-receiving elements of the first sub-scanning size sensor 161. If there is a document directly above the first sub-scanning size sensor 161, the first sub-scanning size sensor 161 thus receives an amount of light reaching or exceeding a particular threshold value (i.e., detects the document) by using the light-receiving elements thereof. If there is no document directly above the first sub-scanning size sensor 161, on the other hand, the amount of light received by the light-receiving elements falls below the threshold value (i.e., the first sub-scanning size sensor 161 does not detect a document). The second sub-scanning size sensor 162 similarly detects or does not detect a document depending on the presence or absence of the document directly above the second sub-scanning size sensor 162.

The user places a document of any size on the first contact glass 155 with an upper corner in the sub-scanning direction of the document set at a document reference position of the first contact glass 155. In this case, the document is in one of the following three states depending on the combination of the size and position of the document. In the first state, an end portion in the sub-scanning direction of the document on the downstream side during the reading is positioned directly above both the first sub-scanning size sensor 161 and the second sub-scanning size sensor 162. In this state, the first sub-scanning size sensor 161 and the second sub-scanning size sensor 162 both detect the document. In the second state, the end portion in the sub-scanning direction of the document on the downstream side during the reading is positioned directly above the first sub-scanning size sensor 161 but not directly above the second sub-scanning size sensor 162. In this state, the document is detected by the first sub-scanning size sensor 161 but not by the second sub-scanning size sensor 162. In the third state, the end portion in the sub-scanning direction of the document on the downstream side during the reading is not positioned directly above the first sub-scanning size sensor 161 or the second sub-scanning size sensor 162. In this state, the document is not detected by the first sub-scanning size sensor 161 or the second sub-scanning size sensor 162.

If a document is placed on the first contact glass 155, the movable irradiation unit 152 located at the document size detection position faces an end portion in the sub-scanning direction of the document on the upstream side during the reading. That is, the document size detection position is a position at which the end portion of the document on the upstream side during the reading faces the movable irradiation unit 152 when the document is placed on the first contact glass 155.

If the user places a document on the first contact glass 155 and starts closing the ADF 51, the opening and closing angle of the ADF 51 starts to decrease from 90°. Then, the opening and closing angle detected by the opening and closing sensor 157 is reduced to 70°. With the opening and closing angle reduced to 70°, the reading control unit 170 determines that an operation of closing the ADF 51 has started. Then, based on the determination, the reading control unit 170 starts a placement mode identification process to identify the mode of placement of the document.

Having started the placement mode identification process, the reading control unit 170 first starts moving the movable irradiation unit 152 and the movable mirror unit 158 backward. The reading control unit 170 then determines in which one of the above-described three states the first sub-scanning size sensor 161 and the second sub-scanning size sensor 162 are (the result of this determination will hereinafter be referred to as the state determination result). The reading control unit 170 further starts the length identification process to identify the length in the main scanning direction of the document by turning on the light source device 100. In the length identification process, the reading control unit 170 first turns on the LED elements included in the light source device 100. The reading control unit 170 then acquires outputs from imaging elements corresponding to a reference determination area (a received light amount) out of the imaging elements included in the image sensor 153. Based on the acquired result, the reading control unit 170 determines the presence or absence of a document in the reference determination area in the main scanning direction.

In the main scanning direction, the reference determination area is located near the document reference position. If the user places a document on the first contact glass 155 in alignment with the document reference position, therefore, the document is in the reference determination area in the main scanning direction. It is to determine whether a document is placed on the first contact glass 155 that the reading control unit 170 first determines the presence or absence of a document in the reference determination area in the length identification process. If the received light amount in the reference determination area detected by the image sensor 153 falls below a particular threshold value, the reading control unit 170 determines that there is no document placed on the first contact glass 155. The reading control unit 170 then causes an operation and display unit 10 (see FIG. 1) of the image forming unit 1 to display an error message “There is no document on the contact glass, or the document is placed at an incorrect position.” If the received light amount in the reference determination area detected by the image sensor 153 reaches or exceeds the particular threshold value, on the other hand, the reading control unit 170 determines that a document is placed on the first contact glass 155. Then, the reading control unit 170 continues the length identification process.

Continuing the length identification process, the reading control unit 170 then acquires outputs from imaging elements corresponding to a first determination area out of the imaging elements included in the image sensor 153. Based on the acquired result, the reading control unit 170 determines the presence or absence of a document in the first determination area in the main scanning direction. If the above-described result reaches or exceeds a particular threshold value, there is a document directly above the first determination area in the main scanning direction. Therefore, the reading control unit 170 determines that the length in the main scanning direction of the document exceeds 182 mm, which corresponds to the length in the shorter direction of a B5-size sheet. The reading control unit 170 then continues the length identification process. If the above-described result falls below the particular threshold value, on the other hand, the reading control unit 170 determines that the length in the main scanning direction of the document is 148 mm, which corresponds to the length in the shorter direction of an A 5-size sheet, or 182 mm, which corresponds to the length in the shorter direction of a B5-size sheet. Whether the length in the main scanning direction of the document is 148 mm or 182 mm is determined based on the document detection result obtained by the first sub-scanning size sensor 161. More specifically, if the above-described detection result indicates the presence of a document, the reading control unit 170 determines that the length in the main scanning direction of the document is 182 mm. If the above-described detection result indicates the absence of a document, the reading control unit 170 determines that the length in the main scanning direction of the document is 148 mm. Then, the reading control unit 170 turns off the light source device 100 and completes the length identification process. Thereafter, the reading control unit 170 identifies the document placement mode based on the combination of the identification result of length in the main scanning direction of the document and the previously obtained state determination result, and completes the placement mode identification process.

If the length in the main scanning direction of the document exceeds 182 mm, the reading control unit 170 acquires outputs from imaging elements corresponding to a second determination area out of the imaging elements included in the image sensor 153. Based on the acquired result, the reading control unit 170 further determines the presence or absence of a document in the second determination area in the main scanning direction. Then, based on the determination result, the reading control unit 170 determines whether the length in the main scanning direction of the document is 210 mm, which corresponds to the length in the longer direction of an A5-size sheet or the length in the shorter direction of an A4-size sheet. More specifically, if it is determined that there is no document in the second determination area, the reading control unit 170 determines that the length in the main scanning direction of the document is 210 mm. If it is determined that there is a document in the second determination area, on the other hand, the reading control unit 170 determines that the length in the main scanning direction of the document is not 210 mm. If the length in the main scanning direction of the document is determined to be 210 mm, the reading control unit 170 turns off the light source device 100 and completes the length identification process. Thereafter, the reading control unit 170 identifies the document placement mode based on the combination of the length identification result and the previously obtained state determination result, and completes the placement mode identification process.

If the length in the main scanning direction of the document is not 210 mm, the reading control unit 170 acquires outputs from imaging elements corresponding to a third determination area out of the imaging elements included in the image sensor 153. Based on the acquired result, the reading control unit 170 further determines the presence or absence of a document in the third determination area in the main scanning direction. Then, based on the determination result, the reading control unit 170 determines whether the length in the main scanning direction of the document is 257 mm, which corresponds to the length in the longer direction of a B5-size sheet or the length in the shorter direction of a B4-size sheet. More specifically, if it is determined that there is no document in the third determination area, the reading control unit 170 determines that the length in the main scanning direction of the document is 257 mm. If it is determined that there is a document in the third determination area, on the other hand, the reading control unit 170 determines that the length in the main scanning direction of the document is 297 mm, which corresponds to the length in the longer direction of an A4-size sheet or the length in the shorter direction of an A3-size sheet. Then, the reading control unit 170 turns off the light source device 100 and completes the length identification process. Thereafter, the reading control unit 170 identifies the document placement mode based on the combination of the length identification result and the previously obtained state determination result, and completes the placement mode identification process.

The reading control unit 170 performs the placement mode identification process (including the length identification process) while moving the movable irradiation unit 152 backward. At the beginning of the placement mode identification process, the movable irradiation unit 152 is basically located at the document size detection position. In this state, the reading control unit 170 starts the backward movement of the movable irradiation unit 152 and the placement mode identification process, and acquires and stores output values from the imaging elements of the image sensor 153 at particular time intervals. The acquisition and storage of the output values is limited to a period taken for the movable irradiation unit 152 to move from one end to the other end of a range of movement thereof during the detection. The reading control unit 170 then calculates the mean value of the output values from the imaging elements stored during the period, determines the presence or absence of reflected light on the document surface based on the calculated result, and identifies the length in the main scanning direction of the document based on the determination result.

The length in the main scanning direction of the document is thus identified based on the mean value of the output values acquired during the time taken for the movable irradiation unit 152 to move from one end to the other end of the range of movement thereof during the detection, thereby improving the accuracy in identifying the length. Specifically, if whether there is reflected light on the document surface in the area corresponding to the imaging elements is determined with the movable irradiation unit 152 unmoved, and if the document size detection position on the document surface happens to be stained, the stain reduces the amount of reflected light on the document surface, causing the risk of falsely detecting that there is no document. If the mean value of the reflected light on the document surface in the range of movement of the movable irradiation unit 152 during the detection is calculated with the movable irradiation unit 152 moved, on the other hand, the risk of falsely detecting the absence of a document due to the stain on the document is reduced, improving the accuracy in identifying the length of the document.

A document separator plate 156 (see FIGS. 1 and 2) is provided between the first contact glass 155 and the second contact glass 154. In the automatically transported document reading mode, the document separator plate 156 facilitates the separation of a document from the second contact glass 154 when the document is automatically transported onto the second contact glass 154.

It is assumed here that, in the placed document reading mode, the movable irradiation unit 152 is correctly located at the document size detection position when the placement mode identification process starts in response to the ADF 51 starting being closed. In this case, the movable irradiation unit 152 is located downstream of the document separator plate 156 when the acquisition and storage of the output values from the imaging elements has completed. The placement mode identification process is completed when the movable irradiation unit 152 is thus located downstream of the document separator plate 156. Then, the movable irradiation unit 152 moves to a position under the document separator plate 156 and reaches a reference position. The reference position is located between the home position and the document size detection position. Upon arrival of the movable irradiation unit 152 at the reference position, the reference position sensor 175 detects the movable irradiation unit 152. The movable irradiation unit 152 then continues to move backward and reaches and stops at the home position.

A configuration of the light source device 100 provided in the scanner 150 of the copier according to the embodiment will be described.

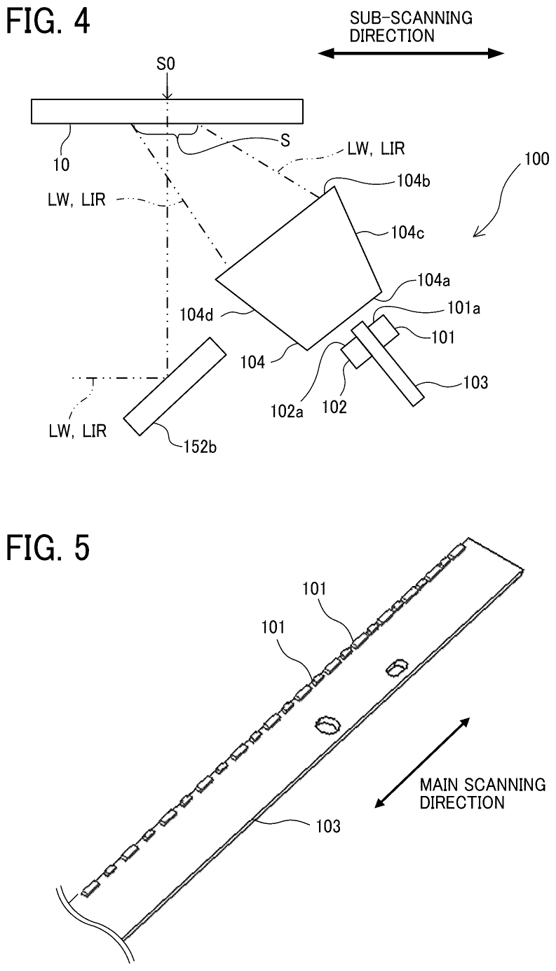

FIG. 4 is a diagram schematically illustrating a configuration of the light source device 100 of the present embodiment. FIG. 5 is a schematic perspective view of a light source substrate of the light source device 100 of the present embodiment.

The light source device 100 includes white light sources 101 as a first light source unit and infrared light sources 102 as a second light source unit. The white light sources 101 are disposed on a first surface (front surface) of a substrate 103. The infrared light sources 102 are disposed on a second surface (back surface) of the substrate 103 opposite to the first surface. The white light sources 101 are formed by a plurality of LED elements that emit white light and are linearly arranged on the first surface of the substrate 103 along an edge portion of the substrate 103 running parallel to the main scanning direction. The infrared light sources 102 are formed by a plurality of LED elements that emit infrared light and are linearly arranged on the second surface of the substrate 103 along the edge portion at a position directly on the back side of the white light sources 101. The white light sources 101 have an emission wavelength ranging from 450 nm to 780 nm, for example. The infrared light sources 102 have an emission wavelength ranging from 850 nm to 900 nm, for example.

An exit surface 101a of each of the white light sources 101 is arranged to face a direction perpendicular to the edge portion of the substrate 103 and parallel to substrate surfaces (mounting surfaces) of the substrate 103. An exit surface 102a of each of the infrared light sources 102 is similarly arranged to face the direction perpendicular to the edge portion of the substrate 103 and parallel to the substrate surfaces (mounting surfaces) of the substrate 103.

The light source device 100 further includes a light guide 104, which forms a light guide unit that guides the white light and the infrared light emitted from the white light sources 101 and the infrared light sources 102, respectively, to an image reading area S for illuminating the document. The light guide 104 is a rod- or plate-shaped member extending in the main scanning direction (a direction perpendicular to the sub-scanning direction), and is made of a resin with a high light transmittance such as acrylic, for example.

As illustrated in FIG. 4, a cross section of the light guide 104 perpendicular to the main scanning direction has an approximately trapezoidal shape, and the light guide 104 is arranged such that an entrance surface 104a thereof faces the exit surface 101a of the white light source 101 and the exit surface 102a of the infrared light source 102. A surface of the light guide 104 opposite to the entrance surface 104a forms an exit surface 104b.

FIG. 6 is a diagram illustrating a state of white light and infrared light guided by the light guide 104. White light LW emitted from the exit surface 101a of the white light source 101 is incident on the entrance surface 104a of the light guide 104 to enter the light guide 104, passes through the light guide 104, and exits from the exit surface 104b of the light guide 104. The white light LW passing through the light guide 104 is fully reflected by a first inner wall surface 104c and a second inner wall surface 104d of the light guide 104 and emitted from the exit surface 104b of the light guide 104.

The exit surface 104b of the light guide 104 of the present embodiment is applied with a diffusing agent as light diffusing means. Thereby, the white light LW and infrared light LIR emitted from the white light sources 101 and the infrared light sources 102 arranged along the main scanning direction are diffused when emitted from the exit surface 104b of the light guide 104. Thereby, the white light LW and the infrared light LIR are homogenized in the main scanning direction, reducing variations in chromaticity and illuminance in the main scanning direction (the width direction of the document) among the white light sources 101 and the infrared light sources 102, which are so-called point light sources.

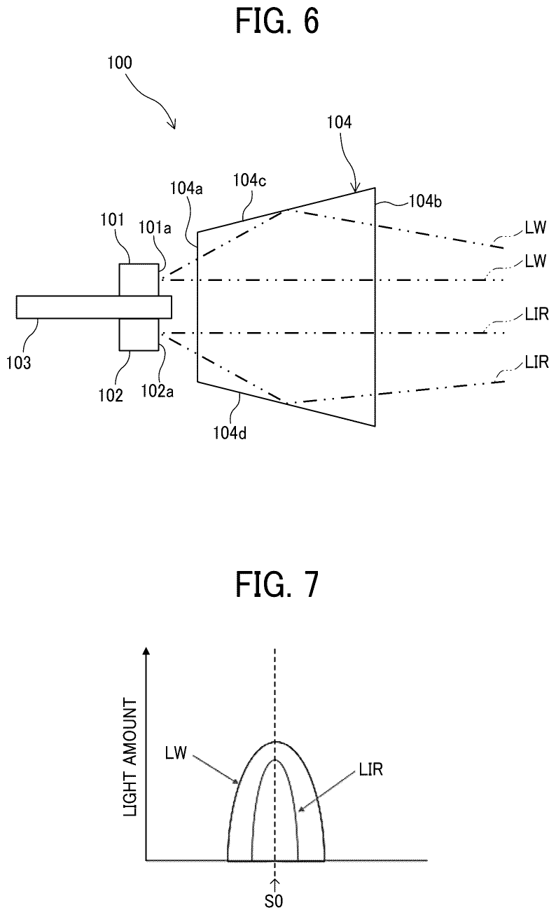

The light guide 104 of the present embodiment is shaped to condense the white light LW emitted from the exit surface 101a of the white light source 101 toward a document reading position S0 (see FIG. 4) in a direction perpendicular to the substrate surfaces of the substrate 103 (i.e., the sub-scanning direction). The document reading position S0 is the center position of the image reading area S in the reading (hereinafter referred to as the reading center position). In a light distribution of the white light LW in the image reading area S, therefore, the light amount peaks at the document reading position S0, with the light amount distribution being substantially symmetrical across the document reading position S0 in the sub-scanning direction, as illustrated in FIG. 7. Consequently, the document reading position S0 is efficiently illuminated with the white light LW emitted from the white light source 101.

Similarly to the white light LW, the infrared light LIR emitted from the exit surface 102a of the infrared light source 102 is also incident on the entrance surface 104a of the light guide 104 to enter the light guide 104, passes through the light guide 104, and exits from the exit surface 104b of the light guide 104. Therefore, the infrared light LIR passing through the light guide 104 is also fully reflected by the first inner wall surface 104c and the second inner wall surface 104d of the light guide 104 and emitted from the exit surface 104b of the light guide 104.

The light guide 104 of the present embodiment is further shaped to condense the infrared light LIR emitted from the exit surface 102a of the infrared light source 102 toward the document reading position S0, i.e., the reading center position of the image reading area S, in the direction perpendicular to the substrate surfaces of the substrate 103 (i.e., the sub-scanning direction). In a light distribution of the infrared light LIR in the image reading area S, therefore, the light amount peaks at the document reading position S0, with the light amount distribution being substantially symmetrical across the document reading position S0 in the sub-scanning direction similarly as in the white light LW, as illustrated in FIG. 7. Consequently, the document reading position S0 is efficiently illuminated with the infrared light LIR emitted from the infrared light source 102.

Herein, the white light sources 101 and the infrared light sources 102 of the present embodiment are disposed on the opposite surfaces of the same substrate 103. In this case, if a light guide with a typical shape is used to guide both the white light LW emitted from the white light sources 101 and the infrared light LIR emitted from the infrared light sources 102 to the image reading area S through the same light guide 104, there arises an issue. That is, the position of the peak of the light amount (hereinafter referred to as the peak light amount position) of the white light LW in the image reading area S and the peak light amount position of the infrared light LIR in the image reading area S are shifted from each other in the direction perpendicular to the substrate surfaces of the substrate 103 (i.e., the sub-scanning direction) due to the difference in the placement position between the white light sources 101 and the infrared light sources 102.

Typically, two light source units disposed on the surfaces of the substrate 103 emit illuminating light beams with the same spectroscopic characteristic. Therefore, the difference in the peak light amount position in the image reading area S (the peak light amount position in the sub-scanning direction) between the illuminating light beams emitted from the two light source units disposed on the surfaces of the substrate 103 does not cause an issue. That is, an overall homogenized light amount distribution is obtained in the image reading area S, if the peak position of a light amount distribution (light distribution) combining these illuminating light beams is aligned with the reading center position of the image reading area S (the document reading position S0).

In the present embodiment, however, the white light LW (the first illuminating light) and the infrared light LIR (the second illuminating light) with different spectroscopic characteristics are emitted from the two light source units disposed on the surfaces of the substrate 103. In this case, if the peak light amount position in the image reading area S (the peak light amount position in the sub-scanning direction) is different between the white light LW and the infrared light LIR, it is difficult to obtain both a homogenized light amount distribution of the white light LW and a homogenized light amount distribution of the infrared light LIR in the image reading area S.

Specifically, if the light guide 104 is configured to align the peak light amount position of the white light LW with the reading center position of the image reading area S, a homogenized light amount distribution of the white light LW is obtained in the image reading area S. In this case, however, the peak light amount position of the infrared light LIR deviates from the reading center position of the image reading area S, making it difficult to obtain a homogenized light amount distribution of the infrared light LIR in the image reading area S. Similarly, if the light guide 104 is configured to align the peak light amount position of the infrared light LIR with the reading center position of the image reading area S, it is difficult to obtain a homogenized light amount distribution of the white light LW in the image reading area S.

In the present embodiment, therefore, the light guide 104 is configured to guide the white light LW and the infrared light LIR to the image reading area S such that the white light LW and the infrared light LIR have a substantially identical peak light amount position in the image reading area S. Specifically, the shape of the light guide 104 is appropriately designed to enable the white light LW and the infrared light LIR to have a substantially identical peak light amount position in the image reading area S. More specifically, the light guide 104 is configured such that the first inner wall surface 104c and the second inner wall surface 104d thereof, which face each other in the direction perpendicular to the substrate surface of the substrate 103 (i.e., the sub-scanning direction), have different angles (to the entrance surface 104a or the exit surface 104b), for example.

According to the present embodiment, the white light LW and the infrared light LIR emitted from the white light sources 101 and the infrared light sources 102 disposed on the surfaces of the substrate 103 have the peak light amount position in the image reading area S aligned with the reading center position of the image reading area S (the document reading position S0). Consequently, both types of illuminating light, i.e., the white light LW and the infrared light LIR, have a homogenized light amount distribution in the image reading area S. Thereby, the image information of the visible light image and the image information of the infrared image are both appropriately obtained.

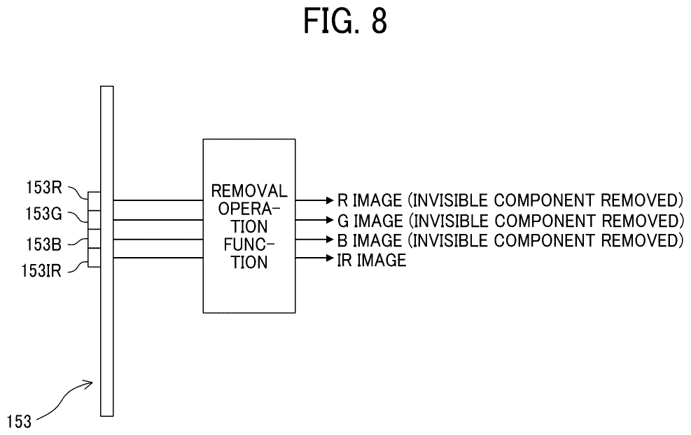

FIG. 8 is a diagram illustrating an example of the image sensor 153 of the present embodiment. As described above, the image sensor 153 of the present embodiment is capable of capturing an image in the visible region (acquiring the image information of the visible light image) and capturing an image in the infrared region (acquiring the image information of the infrared image as the invisible light image). Specifically, the image sensor 153 includes light-receiving elements 153IR for reading infrared light in addition to light-receiving elements 153R for reading red color, light-receiving elements 153G for reading green color, and light-receiving elements 153B for reading blue color, with the light-receiving elements 153R, 153G, 153B, and 153IR being distributed and arranged in an array.

The light received by the light-receiving elements 153IR for reading infrared light is limited to infrared light not including a visible light component. Therefore, the data of an infrared image (IR image) read with the light-receiving elements 153IR for reading infrared light (invisible light image information) forms an infrared light image not including a visible light component. Each of the light-receiving elements 153R, 153G, 153B for visible light to read the corresponding color, on the other hand, receives infrared light in addition to the light of the corresponding color component. Therefore, the data of a visible light image read with the light-receiving elements 153R, 153G, and 153B for the respective colors (visible light image information) is image data including a visible light component added with an infrared light component.

The present embodiment uses a removal operation function to calculate the visible light image. The removal operation function removes the data of the infrared image (IR image) read with the light-receiving elements 153IR for reading infrared light from the data of the visible light image read with the light-receiving elements 153R, 153G, and 153B for the respective colors (visible light image information). The visible light image obtained thereby does not include an infrared light component. Therefore, a visible light image close to a visually perceived image of the document is obtained, improving the image quality of the visible light image.

The above description of the present embodiment has been given of an example using LEDs as the light source units. However, the light sources are not limited to LEDs.

The above description of the present embodiment has also been given of a case in which the illuminating light beams with different spectroscopic characteristics emitted from the first light source unit and the second light source unit disposed on the surfaces of the substrate 103 are white light and infrared light. However, the illuminating light beams are not limited thereto. For example, the illuminating light beams may be visible light beams with different spectroscopic characteristics such as white light and blue light, or may be invisible light beams with different spectroscopic characteristics such as infrared light and ultraviolet light.

The examples described above are illustrative. The present disclosure provides one or more specific effects for each of the following aspects.

According to a first aspect, an image reading device (e.g., the image reading unit 50) includes a first light source unit (e.g., the white light sources 101), a second light source unit (e.g., the infrared light sources 102), and an image reader (e.g., the image sensor 153). The first light source unit is disposed on a first surface of a substrate (e.g., the substrate 103 for light sources). The second light source unit is disposed on a second surface of the substrate opposite to the first surface. The image reader reads an image of a reading target (document) in an image reading area (e.g., the image reading area S) irradiated with illuminating light from the first light source unit and illuminating light from the second light source unit. The image reading device further includes a light guide unit that guides first illuminating light (e.g., the white light LW) emitted from the first light source unit and second illuminating light (e.g., the infrared light LIR) emitted from the second light source unit to the image reading area through a light guide (e.g., the light guide 104). The first light source unit and the second light source unit emit illuminating light beams with different spectroscopic characteristics (e.g., the white light LW and the infrared light LIR). The light guide unit guides the first illuminating light and the second illuminating light to the image reading area such that a peak light amount position of the first illuminating light in the image reading area and a peak light amount position of the second illuminating light in the image reading area are substantially identical.

As a configuration for homogeneously guiding illuminating light from a light source unit to an image reading area, a light guide unit is normally used which guides the illuminating light from the light source unit to the image reading area through a light guide. In a configuration using such a light guide unit, first illuminating light emitted from a first light source unit disposed on a first surface of a substrate and second illuminating light emitted from a second light source unit disposed on a second surface of the substrate are both guided to the image reading area through the light guide. In this case, a peak light amount position of the first illuminating light in the image reading area and a peak light amount position of the second illuminating light in the image reading area may be shifted from each other due to the difference in the placement position between the first light source unit and the second light source unit. Typically, the first light source unit and the second light source unit disposed on the surfaces of the substrate emit illuminating light beams with the same spectroscopic characteristic. Even if the first illuminating light and the second illuminating light have different peak light amount positions in the image reading area, therefore, an overall homogenized light amount distribution is obtained in the image reading area, if the peak position of a light amount distribution combining the first illuminating light and the second illuminating light is aligned with a reading center position of the image reading area, for example.

In the present configuration, however, the first illuminating light and the second illuminating light with different spectroscopic characteristics are emitted from the first light source unit and the second light source unit disposed on the surfaces of the substrate. In this case, if the peak light amount position in the image reading area is different between the first illuminating light and the second illuminating light, it is difficult to obtain both a homogenized light amount distribution of the first illuminating light and a homogenized light amount distribution of the second illuminating light in the image reading area. That is, if the peak light amount position of one of the first illuminating light and the second illuminating light is aligned with the reading center position of the image reading area, for example, the one of the first illuminating light and the second illuminating light has a homogenized light amount distribution in the image reading area. In this case, however, the peak light amount position of the other one of the first illuminating light and the second illuminating light deviates from the reading center position of the image reading area. Consequently, the other one of the first illuminating light and the second illuminating light does not have a homogenized light amount distribution in the image reading area.

In view of the above, the light guide unit according to the first aspect is configured to guide the first illuminating light and the second illuminating light to the image reading area such that the first illuminating light and the second illuminating light have a substantially identical peak light amount position in the image reading area.

The above-described light guide unit is implemented by, for example, designing an appropriate shape for the light guide that guides the first illuminating light and the second illuminating light. According to the first aspect, the first illuminating light and the second illuminating light emitted from the first light source unit and the second light source unit disposed on the surfaces of the substrate have the peak light amount position in the image reading area aligned with the reading center position of the image reading area, for example. Thereby, the first illuminating light and the second illuminating light both have a homogenized light amount distribution in the image reading area, enabling appropriately illuminating the reading target with the first illuminating light and the second illuminating light. Consequently, a first image read with the first illuminating light emitted from the first light source unit disposed on the first surface of the substrate (an image corresponding to the spectroscopic characteristic of the first illuminating light) and a second image read with the second illuminating light emitted from the second light source unit disposed on the second surface of the substrate (an image corresponding to the spectroscopic characteristic of the second illuminating light) are both appropriately read.

According to a second aspect, in the image reading device of the first aspect, the peak light amount position of the first illuminating light in the image reading area and the peak light amount position of the second illuminating light in the image reading area are substantially identical to a reading center position of the image reading area (e.g., the document reading position S0). Thereby, the respective light amounts of the first illuminating light and the second illuminating light are maximized at the reading center position of the image reading area, enabling illuminating the document more efficiently.

According to a third aspect, in the image reading device of the first or second aspect, the first illuminating light includes visible light (e.g., the white light LW), and the second illuminating light includes invisible light (e.g., the infrared light LIR). Thereby, both a visible light image and an invisible light image are read.

According to a fourth aspect, in the image reading device of the third aspect, the first illuminating light is the white light LW, and the second illuminating light is the infrared light LIR. Thereby, both a full-color image and an infrared image are read.

According to a fifth aspect, in the image reading device of the third or fourth aspect, the image reader includes a visible light image reader and an invisible light image reader. The visible light image reader (e.g., the light-receiving elements 153R for reading red color, the light-receiving elements 153G for reading green color, and the light-receiving elements 153B for reading blue color) receives reflected light of the first illuminating light reflected by the reading target to read a visible light image of the reading target. The invisible light image reader (e.g., the light-receiving elements 153IR for reading infrared light) receives reflected light of the second illuminating light reflected by the reading target to read an invisible light image of the reading target. Thereby, both a visible light image and an invisible light image are read.

According to a sixth aspect, an image forming apparatus (e.g., a copier) includes image reading means for reading an image of a document and image forming means for forming an image on a sheet. The image forming apparatus uses the image reading device of one of the first to fifth aspects as the image reading means. Thereby, an image forming apparatus is provided which includes an image reading device that appropriately illuminates the reading target with the illuminating light beams with the different spectroscopic characteristics emitted from the first light source unit and the second light source unit disposed on the surfaces of the substrate.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image reading device comprising:
a plurality of first light sources disposed on a first surface of a substrate to emit first illuminating light;
a plurality of second light sources disposed on a second surface of the substrate opposite to the first surface to emit second illuminating light;
an image reading sensor to read an image of a reading target in an image reading area irradiated with the first illuminating light and the second illuminating light, the first illuminating light and the second illuminating light having different spectroscopic characteristics; and
a light guide device to guide the first illuminating light and the second illuminating light to the image reading area via a light guide such that a peak light amount position of the first illuminating light in the image reading area and a peak light amount position of the second illuminating light in the image reading area are substantially identical.

2. The image reading device of claim 1, wherein the peak light amount position of the first illuminating light in the image reading area and the peak light amount position of the second illuminating light in the image reading area are substantially identical to a reading center position of the image reading area.

3. The image reading device of claim 1, wherein
the first illuminating light includes visible light, and
the second illuminating light includes invisible light.

4. The image reading device of claim 3, wherein
the first illuminating light is white light, and
the second illuminating light is infrared light.

5. The image reading device of claim 3, wherein the image reading sensor includes
a plurality of first light-receiving elements to receive reflected light of the first illuminating light reflected by the reading target to read a visible light image of the reading target, and
a plurality of second light-receiving elements to receive reflected light of the second illuminating light reflected by the reading target to read an invisible light image of the reading target.

6. An image forming apparatus comprising:
the image reading device of claim 1; and
an image forming device to form an image on a sheet.
